(19) United States
(12) Patent Application Publication
(10) Pub. No.: US 2017/0266951 A1
(43) Pub. Date: Sep. 21, 2017

(54) SYSTEMS AND METHODS OF IMPROVED DIGITAL INK SUPPLY

(71) Applicant: QUAD/TECH, INC., SUSSEX, WI (US)

(72) Inventors: John Kitscha, Brookfield, WI (US); Gower Koebler, Roscoe, IL (US)

(73) Assignee: QUAD/TECH, INC., SUSSEX, WI (US)

(21) Appl. No.: 15/459,525

(22) Filed: Mar. 15, 2017

Related U.S. Application Data
(60) Provisional application No. 62/310,264, filed on Mar. 18, 2016.

(51) Int. Cl. B41F 31/04; B41F 17/14

(52) U.S. Cl. CPC B41F 31/04; B41F 17/14

(57) ABSTRACT

An apparatus for inking a roller of a decorator press for printing on metal cans has a main body disposed the decorator press, the main body having a blade holder portion. A plurality of ink inlets is spaced longitudinally along the length of the main body or the blade holder portion. The ink inlets lead to a plurality of ink channels terminating downstream from the inlets. A blade is coupled to the blade holder portion, the blade configured to spread ink from the plurality of ink channels onto the roller of the decorator press. An adjustment device is configured to provide movement of the blade from a first operating position coupled to the blade holder to a second operating position coupled to the blade holder.

### BACKGROUND

The present application relates generally to printing presses and more specifically to systems and methods for supplying ink to a decorator press.

### BRIEF DESCRIPTION OF THE DRAWINGS

FIG. 1 is a block diagram of a printing press, according to an illustrative embodiment;

FIG. 2 is a vertical sectional view of one injector of a distribution head, according to an illustrative embodiment;

FIG. 2A is a partial vertical sectional view of one injector of a distribution head, according to another illustrative embodiment.

FIG. 2B is a partial vertical sectional view of one injector of a distribution head, according to another illustrative embodiment.

FIG. 3 is a side elevational view, partly diagrammatic in character, and showing a digital inking system, according to an illustrative embodiment;

FIG. 4 is a vertical sectional view of one injector of a distribution head, according to an illustrative embodiment;

FIG. 5 is a view taken along lines 3-3 of FIG. 4 and showing several of the ink patterns made by the ink distributors, according to an illustrative embodiment;

FIG. 6A is a cross sectional view of a distribution head, according to an illustrative embodiment;

FIG. 6B is a cross sectional view of a distribution head, according to an illustrative embodiment;

FIG. 7A is a cross sectional view of a distribution head, according to an illustrative embodiment;

FIG. 7B is a cross sectional view of a distribution head, according to an illustrative embodiment;

FIG. 8A is a perspective view of a pump unit, according to an alternative embodiment;

FIG. 8B is an exploded perspective view of the pump unit of FIG. 8A;

FIG. 8C is another exploded perspective of the pump unit of FIG. 8A.

FIG. 9A is a perspective view of a frame assembly for inking a roller, according to an illustrative embodiment.

FIG. 9B is an exploded view of a distribution head showing a blade, according to an exemplary embodiment;

FIG. 10 is a cross sectional view of a portion of a distribution head showing several of the ink patterns made by the ink distributors, according to an illustrative embodiment; and

FIG. 10A is a cross sectional view of a portion of a distribution head showing several of the ink patterns made by the ink distributors, according to an illustrative embodiment.

FIG. 11 is a partial vertical sectional view of one injector of a distribution head, according to another illustrative embodiment.

FIG. 12 is a block diagram of a digital inking system, according to another illustrative embodiment.

FIG. 13 is a graphical user interface screen, according to an exemplary embodiment.

### DETAILED DESCRIPTION OF ILLUSTRATIVE EMBODIMENTS

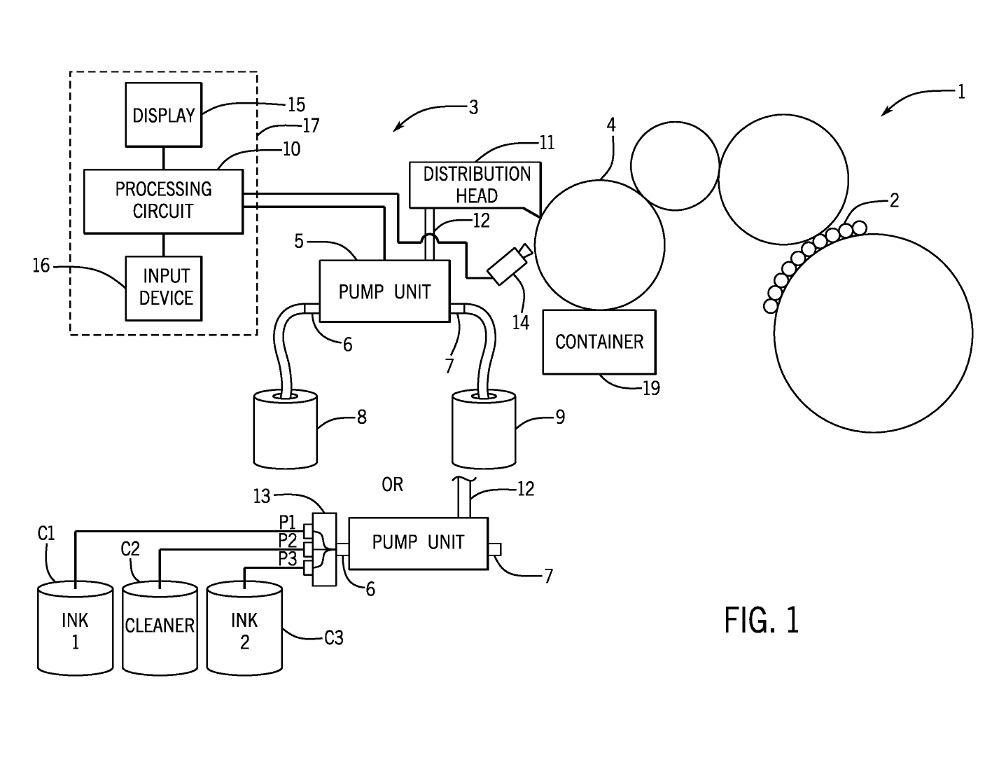

Referring now to FIG. 1, a block diagram of a printing press 1 will be described, according to an illustrative embodiment. In this embodiment, the printing press is a decorator press for printing on metal cans 2. The printing press may be any type of web offset press, sheet fed press, non-offset presses such as gravure presses, newspaper presses, etc. Press 1 comprises a digital ink supply system 3 which uses pumps under computer control to feed ink to a roller 4 of the press. The press may comprise one or more rollers in various embodiments to bring the ink to the cans 2 or other products to be printed.

In this embodiment, system 3 comprises a pump unit 5 comprising a plurality of inlet ports 6, 7, a first inlet port 6 configured to receive an ink of a first color from a first ink source 8 and a second inlet port 7 configured to receive a fluid from a second fluid source 9. Each inlet port may comprise a valve configured to open and close the port partially and/or fully, which may be manually operated by way of a handle and/or computer controlled by way of a control signal received from processing circuit 10 over a wired or wireless connection. In a computer controller embodiment, the signal is configured to control an actuator, such as a motor, to open and/or close the respective port partially and/or fully. While two ports are illustrated in this embodiment, three or more ports may be used in alternate embodiments.

Each of fluid sources 8 and 9 (or more) may comprise inks of different colors or a cleaning solution. For example, the cleaning solution may comprise a clear, pigment-free ink, a highly viscous cleaner, a less viscous cleaner, or other cleaning fluids or solutions. Fluid source 8 and 9 may comprise a bucket or other holding tank which may be configured to hold the fluids.

In an alternative embodiment, a manifold or distributor 13 may be used to channel one of a plurality of different fluids to pump unit 5, as shown in FIG. 1. Manifold 13 may comprise any number of ports, though three ports P1, P2 and P3 are provided in this exemplary embodiment. Manifold 13 may comprise electronically controlled valves that open or close ports P1, P2, P3 as needed to channel the correct fluid from containers C1, C2, C3 to pump unit 5. Manifold 13 may be integrally formed with and/or part of pump unit 5 or be a separate device coupled to pump unit 5 with conduits.

System 3 further comprises a distribution head 11 joined to pump unit 5 by one or more fluid conduits 12. Distribution head 11 may be configured to receive fluids from pump unit 5 and provide or spread the fluids received from pump unit 5 across a print roller. Pump unit 5 and distribution head 11 may each comprise a separate enclosed housing coupled together with tubing or other conduit(s). Pump unit 5 may comprises one or more separate fluid pumps and distribution head may further comprise one distribution port or channel or conduit corresponding to each separate fluid pump. For example, each distribution port may be configured to source fluid from a corresponding positive displacement pump to a different zone of a roller on the printing press. Further, distribution ports and/or separate fluid pumps within pump unit 5 may be individually configurable by processing circuit 10 to turn on/off, operate at different speeds, etc.

A separate conduit 12 (e.g., tubing, etc.) may run between each separate fluid pump to each channel within the distribution head. In one embodiment, at least four separate pumps/channels are provided. In another embodiment, at least eight separate pumps/channels are provided. In alternative embodiments, one separate pump may feed a plurality of channels or one channel may be fed by a plurality of separate pumps. Pump unit 5 may be configured for positive displacement pumping of fluids or other methods of pumping fluids.

A sensing device 14 may be coupled to the press (e.g., physically, via a bracket or other mechanical part) and configured to sense a characteristic of fluid flowing out of distribution head 11. Sensing device 14 may comprise a viscosity sensor, a light sensor, a color sensor, or other type of sensing device. Sensing device 14 may be configured to sense light reflecting from the ink or other fluid as the fluid flows along a portion of distribution head 11, out of distribution head 11, into a collection container 19, etc. Alternatively, sensor 14 may be housed within the housing of distribution head 14 and configured to image fluid as it flows through a channel or conduit of one of the distribution ports of head 11.

A computer controller 17 may comprise a processing circuit 10 configured to receive the sensed characteristic, compare the sensed characteristic to a predetermined threshold, and to provide an indication to a display 15 based on the comparison. Processing circuit 10 may do so under control of a programmed microprocessor or other circuit, and may do so in response to a request received from input device 10 (e.g., a keyboard, touch screen, speech recognition input, and/or mouse, etc.) or automatically without requiring user input. The indication on display 15 may comprise illuminating a light-emitting diode (in a simple form of a display), or may comprise a message in text form, color, flashing indicator on a display screen (e.g., LCD display, etc.) and may be accompanied by an audible indication. In another embodiment, processing circuit 10 may be configured to monitor the sensed characteristic and, when it meets a threshold criteria, processing circuit 10 may be configured to stop or redirect the flow of ink away from a waste collection container 19. Processing circuit 10 may be configured to provide other control outputs based on the sensed characteristic. For example, processing circuit 10 may further be configured to stop the pumping operation of pump unit. In another embodiment, processing circuit 10 may further be configured to activate the decorator to begin a printing operation.

Computer controller 17 may comprise wired and/or wireless inputs and outputs for communication with and/or control of the various components described in FIG. 1

In one example, the fluid comprises an ink having a color and the sensing device is configured to sense the color or spectral response of the fluid passing out of the distribution head. The predetermined threshold may be a predetermined threshold stored in any of a number of color spaces, such as a CIE L*a*b* color space, CIELUV color space, RGB, CMYK, sRGB, etc. In one embodiment, processing circuit 10 may be configured to store a table of a plurality of color values and/or viscosities for different inks, cleaners or other fluids to be used on press 1 (e.g., three or more color values, five or more color values, etc.). Processing circuit 10 may be configured to determine if the sensed color or viscosity of the fluid sensed by sensor 14 is within a tolerance of any of the values stored in the table and, if so, provide an indication of such on display 15.

In one alternative, either of ports 6 or 7 may comprise a two-way port configured to allow fluid to flow in either direction.

In another alternative, the sensed characteristic of the fluid can be displayed on the display as it is monitored (e.g., received, filtered, etc.), thereby allowing an operator to decide when the second fluid has passed through sufficiently to begin the next operation.

The system of FIG. 1 may be used to in the vicinity of, coupled to, or otherwise working with a printing press, such as a decorator press, which may be used to print a plurality of different colors of inks. For example, a batch of metal cans (which can be associated with a certain label) may be printed with a red ink, a black ink, a white ink, and/or other inks. In some cases, the press or one or more parts of the press must be cleaned between inks during a label change. A decorator press may have different colors printed from different print cylinders disposed at different locations around a Ferris wheel-shaped or circular shaped press arrangement.

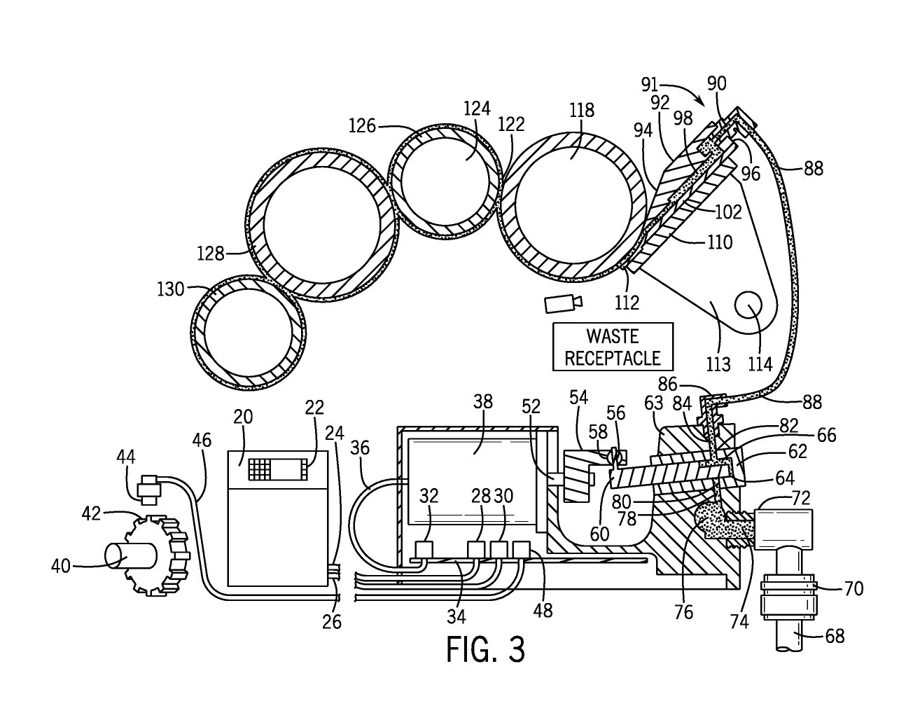

Referring now to FIG. 3, a press comprising a digital inking system will be described according to various embodiments. The press includes a computer controller, shown in this embodiment as a keyboard or control unit. The press may further include a digital ink pump assembly, a swing frame, and plural injector pumps for inking the first of several rollers placed in a series relationship. The press also includes a transfer blade and several stages of “fanning out” the ink supplied by the digital ink pumps.

A keyboard 20 may have a plurality of keys 22 thereon, the keyboard 20 capable of sending instructions from the keys through the lines 24, 26. Keyboard 20 includes keys for instructing the unit how much ink to flow, either collectively or individually. Keys may include a single key for increasing all flow, while the individual keys may permit one pump to handle more ink, while another pump less.

In an alternate embodiment, the computer controller may comprise an operator control unit running graphical user interface software on a touch screen to allow a user to control different ink keys or zones and different color distribution head/pump arrangements pursuant to operator inputs, preprogrammed controls, or other control programs.

The instructions sent by the keys are forwarded along lines 24, 26 to keyboard elements 28, 30. Here, the messages are forwarded from the individual elements 28, 30 to a plurality of output drivers 32 contained on a circuit board 34. Each driver is connected, as by a line 36, to an armature of an individual ink pump 38. Although one pump is shown for clarity, there may be eight such ink pumps in each array of digital pumps, or any other number of pumps.

In addition to the control achieved by the individual pumps, cumulative control is achieved by a line shaft 40 which contains a toothed wheel 42. As the line shaft rotates, (at whatever speed) this wheel 42 sends a digital signal picked up by the detector 44 and sent along the lines 46 to drive element 48. The clocking pulse therefore comes from the line shaft, and the individual pulses come from the individual pumps. In this way, the ink is delivered to the rollers. The keyboard thus controls the output of each pump relative to another, and the line shaft 40 and its associated gears 42, 44 controls the speed at which the ink pumps are ultimately operated. The line shaft may be attached to the press, for example at one of the rollers, so that press line speed correlates with ink pump speed.

The armature 38 of the drive motor, when actuated, turns a rotary shaft 52. The crank pin 54 is driven at a speed which is equal to the speed of the shaft. A carrier bearing 56 is adapted to receive a drive pin 58 from the piston pump 60. The piston pump 60 rotates, and because of its inclination and because its drive link portion is offset from the axis of the piston, as the piston moves in and out, relative to its housing 62, it pumps fluid therefrom.

A plurality of individual pumps 60 may be arrayed together within a single housing 62, and a drive motor 38 may be provided for each of the pumps. The motors for the pumps may be stepper motors, or another type of motor. In the arrangement shown, a digital control circuit provides timed output pulses, and each output pulse results in a very small step of the motor, which may require 200 to 400 steps per revolution in an exemplary embodiment. The digital pulse train thus controls the power supplied to the motors and provides communications or instructions, while the line shaft component, which advises the microcomputers of the press speed, regulates the speed and hence the overall output rate of all the pumps.

Piston 60 includes a solid portion 64 and a cutaway relief portion 66. As the pump rotates, the rotation and reciprocation of the piston causes ink flow in the system, as follows. The ink is drawn up from a master supply 68 through a fitting 70 and then to the through opening 72 leading into a longitudinal gallery 74 which extends the length of the block containing the cylinders. The main ink flow for each piston 60 is through an individual inlet for each piston 60, with the ink 78 being drawn into the inlet area 80 of the pump as the piston 60 is withdrawn. Shortly thereafter, the outlet port 82 comes into registry with the relieved portion 66, causing the ink 84 to flow from there through a fitting 86 and out the outlet 88.

From here, the ink proceeds into a fitting 90, and there the ink passes to the distribution head 91, which will now be described. The distribution head comprises a main body portion 92 in which the fitting 90 is received. The exterior of the distribution head includes an exterior surface 94 with a slight slope to it. The rear surface 96 is substantially flat. The bottom includes a main portion or conduit 98 for ink, most of which conduit is of a relatively small width, while the balance of the ink channel terminates in a spreader or fan-out position 100. The remainder is flat, as at 97, so as to mate with the blade holder 102. Hence, ink that is trapped in this area must be spread or fanned out and assume the position of FIG. 5.

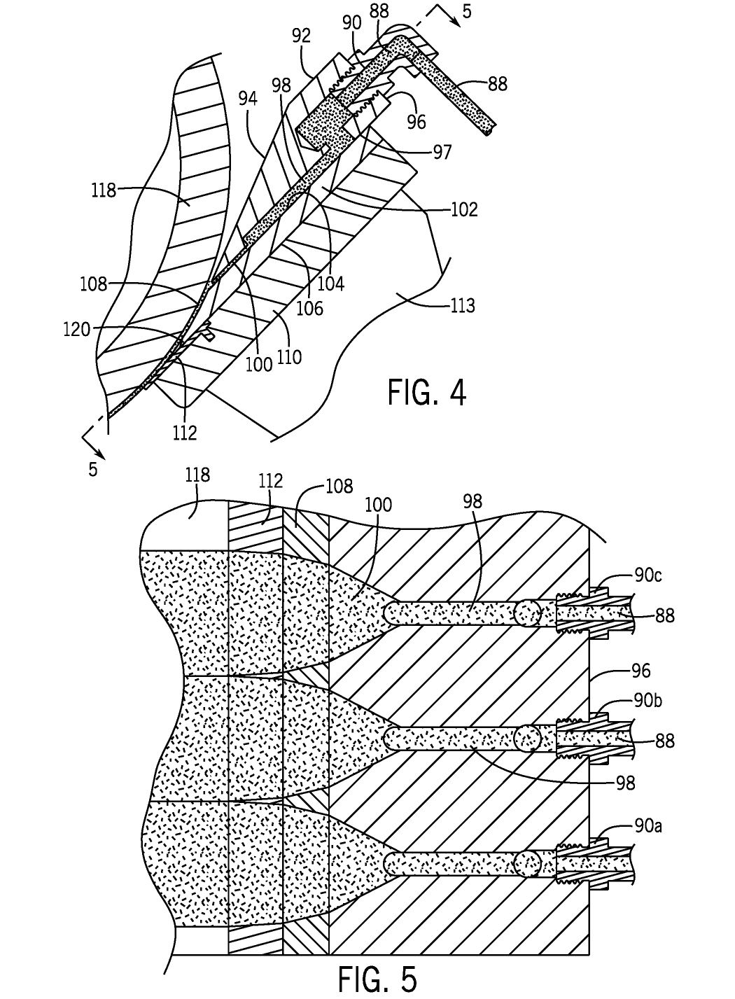

Referring to FIG. 4, beneath the body portion 92 containing the ink is a blade holder unit 102. This unit has an upper, flat portion 104, a lower flat portion 106, and a front portion 108 that is tapered to approximately the same extent as its counterpart 94. A blade support 110 lies beneath the blade holder 102, and contains a notch, of greater or less length, for holding a blade 112. The blade support 110 is formed separately from, or as a part of the swing frame 112, which pivots about point 114 (FIG. 3).

For each of the digital ink pumps delivering a charge of ink, (which may be in varying quantities), the first roller in the sequence, i.e., the fountain roller 118 contacts and picks up a supply of ink. This roller 118 is spaced from the blade and the blade support by a working distance or clearance 120. The next roller is spaced by a working clearance 122 that lies between a micrometric roller 124 and the fountain roller 118. This micrometric roller 124, which may contain a knurled surface 126, operates at web speed, whereas the roller 118 operates at a lower speed, in this exemplary embodiment. The web speed or transfer roller 128 is normally made from a rubber material, and this transfer roller 128 operates also at web speed. Attached to the transfer roller is the oscillating roller 130. Other rollers may be provided.

By referring to FIGS. 4 and 5, the operation can be more clearly viewed. The ink is shown to be spread from its region of concentration 90, 90a, 90b, etc. to an area in which it is dispersed, finally reaching a tangent point to that of an adjacent discharge. The blade does not move, but serves to spread or transfer the ink evenly, to the extent this has not been done already.

With the digital pumps set to self-adjust to the new ink flow requirement on a column-by-column basis, this occurs constantly as press speed varies. Press speed information is “broadcast” to each page pack, allowing this adjustment to be performed thousands of times each second providing improved accuracy. In a condition where little or no ink is required, the blade may still be maintained at a constant distance from the roller, but the pump supplies no ink and consequently, the zone is empty.

In one embodiment, there may be no physical or mechanical connection between the press and the digital ink supply system. In alternate embodiments, one or more components of the digital ink supply system may be coupled to components of the press, such as a housing or mounting bracket.

The pump units may be purged of the color very rapidly. The swing frame may be taken back into its non-operating position and the ink may be rapidly purged by running through the pumping cycle a number of times. Thus, a high speed purge may be made of all of the ink pumps, without having to disconnect anything from the press. This can provide much faster color changes.

The density, and other adjustments, may be made from the keyboard or console.

Control of ink put on the paper may be achieved volumetrically. In one embodiment, the digital inking system may add a certain, fixed amount of ink with each revolution of the roller, and no water may be fed back.

The digital inking system may be retrofitted to existing presses. For example, for a press which is equipped with an ink bath or similar type arrangement, the swing frame 112, which pivots about 114, may be withdrawn and removed in order to use the ink bath.

In some embodiments, there may be one of these pump units for every color of ink used in the press. This could be advantageous in a four, five or six color press. In one example, everything back of the rollers could be replaced in the depiction of FIG. 3. Of course, the pivot pin and the swing frame portion per se of the press need not be replaced in total, assuming that the portion from the blade support on were replaced.

In various embodiments, a keyboard can be placed next to the digital inking system, or it can be centralized at a console. The option of having both the keyboard and a console offers options in press ink and water control.

Regarding options available with the system, it is possible to allow the console to measure ink usage. In fact, this may be done all the way down to the per column level. This makes it possible to track consumables down to a fine degree. The optional press controls can provide features such as a noise immune fiber optic communication at high speed.

The keyboards may be “smart” and may remember their last settings. Accordingly, if there is a power failure, the correct settings will not be affected.

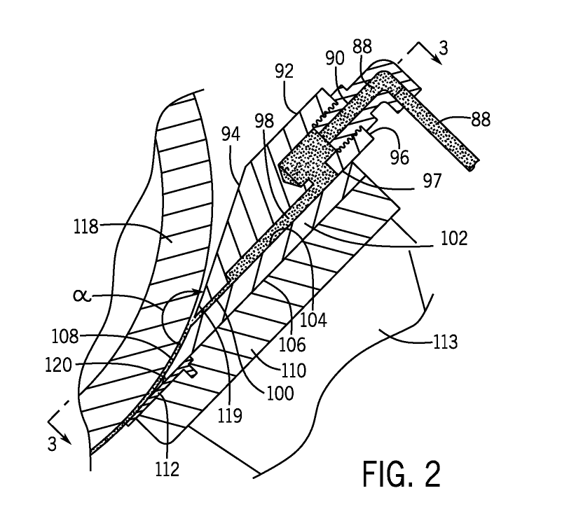

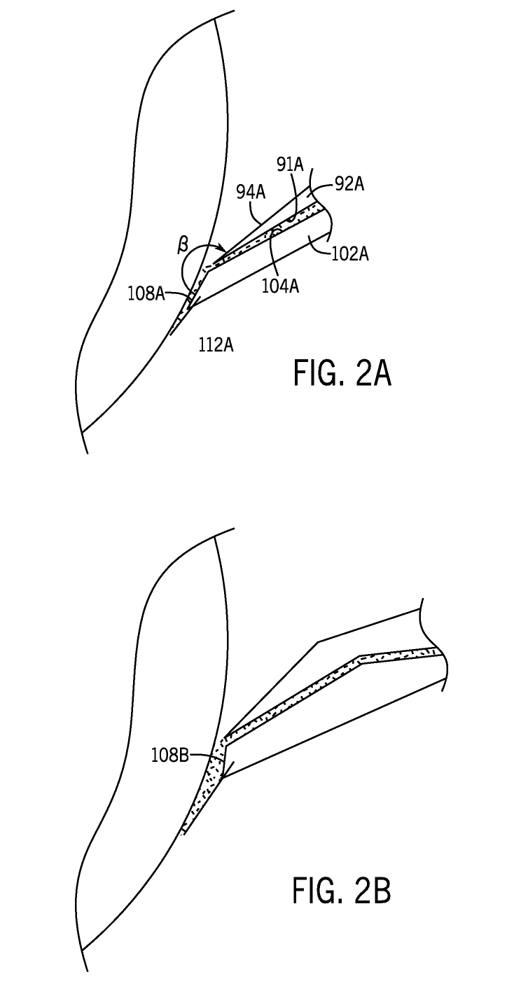

Referring now to FIG. 2, an alternative embodiment of an inking apparatus will be described. In this embodiment, front face or surface 94 of main body 92 has a non-parallel relationship to front face or surface 108 of blade holder 102. In one embodiment, main body 92 and blade holder 102 may be one integrally molded piece having front face 94 and front face 108. In an alternative embodiment, main body 92 and blade holder 102 may be two separate, distinct pieces, each separately fabricated.

In this embodiment, front face 94 and front face 108 are disposed at an angle alpha (shown in FIG. 2), wherein the angle alpha may be less than 180 degrees, for example less than 175 degrees. In another embodiment, angle alpha may be more than 180 degrees, for example more than 185 degrees. In another embodiment in which the faces 94 and 108 are non-parallel, they may no share a pivot point such as point 119, but instead may be on different planes which are parallel or non-parallel to each other. Face 94 may be canted relative to face 108. In another embodiment, face 94 may lie on a plane that cuts through blade holder 102 at any place along the length of its elongated side shown in FIG. 2.

Referring now to FIG. 2A, in this embodiment, a front face 94A of a first portion 92A of a distribution head is disposed in a non-parallel relationship to a front face 108A of a second portion 102A of a distribution head. In this example, front faces 94A and 108A are disposed at an angle beta (B) relative to each other. Angle Beta may be greater than 180 degrees, such as greater than 185 degrees, or greater than 200 degrees.

Also in the embodiment of FIG. 2A, blade 112A is disposed in a slot within blade holder portion 102A of the distribution head. Blade 112A may be coupled to blade holder portion 102A using an interference fit, a weld, a fastener (such as a screw), or by other mechanisms or arrangements.

Also in the embodiment of FIG. 2A, an ink channel or pathway may be defined by an inner surface 91A of portion 92A and an inner surface 104A of second portion 102A of the distribution head. In this embodiment, inner surfaces 91A and 104A are disposed at an angle relative to each other such that the ink channel grows continually narrower over at least a portion of the length of the channel. The narrowing may be in one dimension (the plane of the page) or two dimensions (the plane of the page and normal to the plane of the page). The narrowing in either or both dimensions may be linear or non-linear. The narrowing in either or both dimensions may be continuous (as on a plane) or in a step-wise fashion.

As shown in the embodiments of FIGS. 2 and 2A, the front surfaces of the portions of the distribution head may be tangent to the roller or, alternatively, one or both surfaces may be non-tangent to the roller. For example, as shown in FIG. 2B, a front surface 108B may also be non-tangent to any surface of the roller.

In some embodiments, making front face 94 non-parallel relative to front face 108 may allow the inking unit to be disposed more closely to roller 118.

In some embodiments, making front face 94 non-parallel relative to front face 108 may result in a larger gap between roller 118 and front face 94 to avoid contact between the two that can smear the ink and potentially damage roller 118.

In some embodiments, making front faces of first and second portions of a distribution head non-parallel can reduce the size and/or weight of the distribution head, and may reduce the cost of materials to manufacture the distribution head.

In some embodiments, non-parallel front faces may accommodate rollers having different sizes/diameters.

In some embodiments, non-parallel front faces may help prevent build-up of ink in the gap between the main body and roller. For example, a smaller cavity may allow less ink to build up in the cavity.

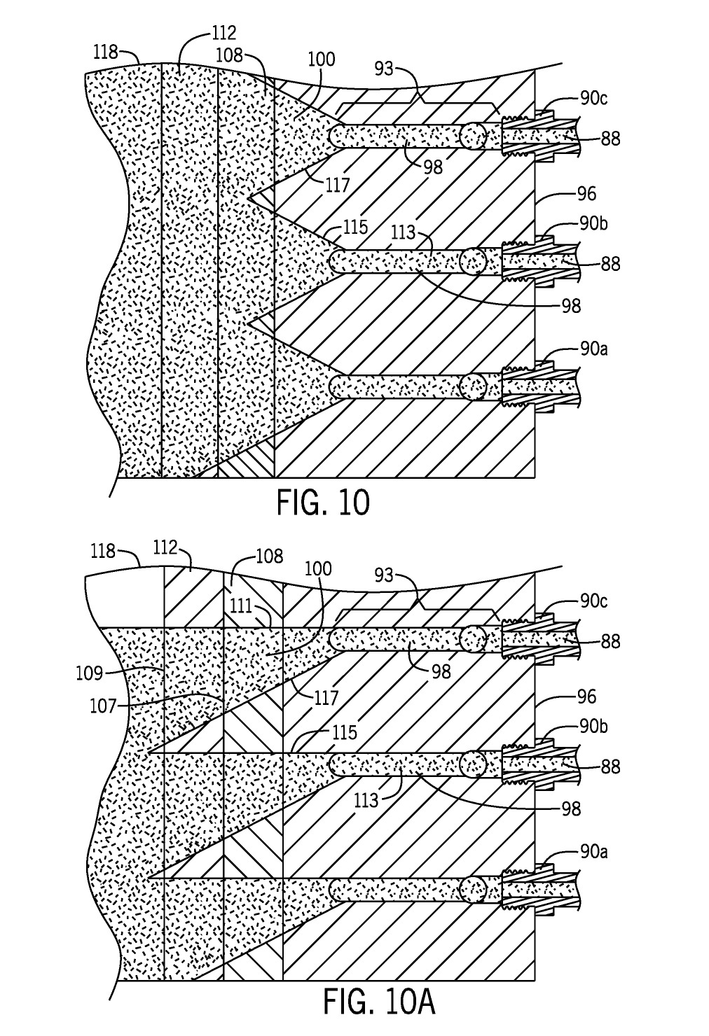

Referring now to FIG. 10, a cross-sectional view of the distribution head of FIG. 2 is shown, according to an exemplary embodiment. In this embodiment, main body 92 and blade holder 102 are separate parts defining ink channels therebetween, though in an alternative embodiment main body 92 and blade holder 102 may be cast, molded, formed, or otherwise manufactured as a single piece. Ink channels or conduits 98 may each comprise a main conduit portion 93 and a spreader portion 100. The main conduit 93 may extend from an ink inlet (88, 90a, b, c, etc.) to spreader portion 100. Spreader portion 100 may have an outer margin 117 that is straight over the entirety of its length extending from main conduit 93 to one of the blade 112 and a spreader portion 115 of a neighboring ink channel 113.

The margins of the spreader portions shown in FIG. 10 may take a variety of configurations. For example, they may extend in a straight line until intersecting a neighboring margin; they may extend in a straight line to blade 112 or roller 118 without intersecting a neighboring margin. Where margins of neighboring or adjacent ink channels intersect, they may intersect to form an acute angle, such as an angle of at least 10 degrees, at least 25 degrees or other angles.

In various embodiment, the ink channels may have a narrow width and a given height, said channels may terminate downstream in spreader portions of gradually decreasing depth and/or of increasing width such that their outer margins extend gradually outwardly in both directions from said channels to points closely adjacent each other.

In various embodiments, a plurality of spreader formations of increasing width and decreasing depth may be formed in the main body, the outer margin of said spreader formations gradually becoming substantially tangent to one another in the area between said main body and said blade holder.

In various embodiments, one or more spreader portions may have a decreasing depth and increasing width from the main conduit to the blade.

Referring now to FIG. 10A, in various embodiments one or more spreader portions may have a second margin 111 opposite a first margin 117, wherein the first margin 117 extends gradually outward in one direction and the second margin 111 extends substantially straight from the main conduit 98 to the blade, roller 118, and/or other position downstream of the ink channel. The second margin 11 may be straight and may further be substantially perpendicular to an edge 109 of blade 112 or to a leading edge 107 of front surface 94, 108 of main body 92. The first and second margins 111, 117 may form any of a variety of acute angles therebetween, such as at least 10 degrees, at least 30 degrees, or at least 60 degrees.

In various embodiments, the spreader portion 100 may have uniform depth and increasing width from the main conduit 98 to the blade 112.

In an alternative embodiments, the straight line margins may be curved lines and/or the spreader portions may be scalloped in shape.

The embodiment of FIG. 10A may be easier to fabricate, faster to machine and less costly than other configurations.

The embodiment of FIG. 10A may be easier to clean, allowing quicker color changes, than other configurations.

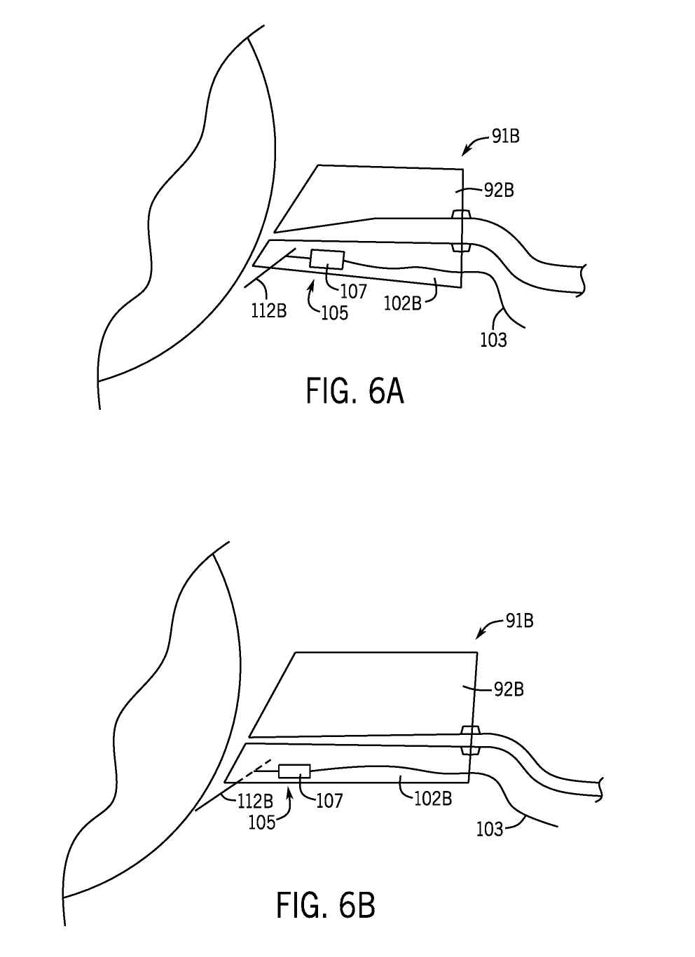

Referring now to FIG. 6A and 6B, additional embodiments will be described in which the blade is adjustable. In this embodiment, a distribution head 91B comprises a main body 92B molded in one piece and comprising a blade holder portion 102B. A blade 112B is coupled to blade holder portion 102B. For example, blade 112B may be slidable retained within a slot or recess of blade holder portion 102B. Blade 112B is configured to spread ink from the ink channel onto the roller of the decorator press for printing on metal cans.

An adjustment device 105 is configured to provide movement of the blade from a first operating position coupled to the blade holder (shown in FIG. 6A) to a second operating position coupled to the blade holder (shown in FIG. 6B). The first operating position may be a retracted position and the second operating position may be an extended position. The apparatus may be configured to apply ink to the roller of the decorator press with the blade in both the first operating position and in the second operating position. The position of the blade may control the thickness of ink applied to the roller. The position of the blade may also be adjusted based on whether distribution head 91B is providing an ink or a cleaner, or fluids with different viscosities or other different characteristics. While two operating positions are shown, in alternative embodiments, the device may be configured for at least three positions, or for more than three positions. In one embodiment, the blade position may be continuously variable to any of a large number of positions over a range of movement from a retracted position (or even fully retracted position) to an extended position (or fully extended position).

In this embodiment, adjustment device 105 comprises an actuator 107 configured to move the blade between the first operating position and the second operation position. For example, the actuator may be a hydraulic actuator, pneumatic actuator or electric motor. A control line 103 may extend from the actuator 107 through a portion of blade holder 102B and out to a processing circuit or other control module configured to control actuator 107 to control movement of blade 112B among a plurality of positions.

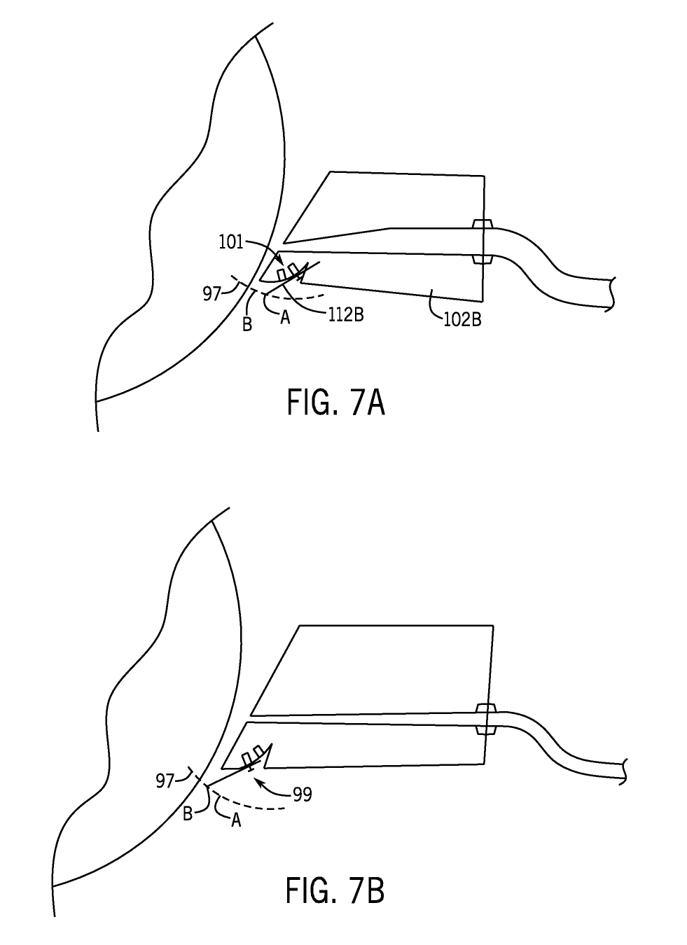

In another embodiment, as shown in FIGS. 7A and 7B, the adjustment device may comprise a plurality of apertures 101 within the blade holder portion and a fastener 99 configured to fasten blade 112B in the first or second operating position by coupling to a respective one of the plurality of apertures. Fastener 99 may comprise a screw, plug, post, or other fastener that can provide coupling by way of threads, interference fit, or other mechanisms. In the manner shown in FIGS. 7A, 7B, an operator can readily adjust the position of the blade among a plurality of operating positions by simply removing fastener 99, manually positioning blade 112B over a second (or third, etc.) aperture, and reinserting the fastener.

Also shown in FIGS. 7A and 7B is another feature combinable with this or other embodiments described herein. Blade 112B may be configured to move linearly from the first operating position to the second operating position as shown in FIGS. 7A and 7B, or may be configured to move along an arcuate path 97 from the first operating position to the second operating position. At the first operating position, a leading tip of blade 112B is at a point A along the arcuate or curved path (as shown in FIG. 7A) and at the second operating position, the same tip of blade 112B is at a point B along the arcuate or curved path (as shown in FIG. 7B). A recess or notch in blade holder portion 102B, within which blade 112B is disposed, may be enlarged relative to other embodiments to accommodate movement of blade 112B along a plurality of positions along one or more arcuate pathways.

In yet another embodiment, the adjustment device may comprise a spring and be hand-operable by a press attendant. For example, the adjustment device may comprise an operating member having a button portion to be pressed by the press attendant, a spring adjacent the operating member to provide a force against which the operating member is pressed, and a recess with the blade holder portion configured to allow setting of the operating member in one of a plurality of operating positions. Blade 112B may be coupled to the operating member so as to move along with the operating member. The recess may comprise a channel for slidably receiving the operating member and a plurality of indentations for receiving a protrusion on the operating member at one of a plurality of preset operating positions. Blade 112B may be configured to spread ink onto the roller in any of the plurality of present positions.

Other adjustment mechanisms are contemplated.

In some embodiments, making the blade adjustable allows finer control of a gap between the blade and the roller.

In some embodiments, the distribution head can be locked into a position relative to the decorator press in a predetermined position and the blade position can be adjusted for fine-tuning the distance between the blade and the roller to be inked.

In some embodiments, the blade can be adjusted in a finer manner to accommodate for different fluids between applied to the roller from the distribution head. For example, a cleaner may be applied with one gap size between blade and roller while an ink may be applied with a different gap size between blade and roller. As another example, a highly viscous ink may be applied with one gap size while a low viscous ink may be applied with a different gap size.

An adjustable blade may advantageously allow a press operator to variably change the gap between blade and roller to accommodate for different viscosity inks. For example, for some inks, a smaller gap may be advantageous to avoid spraying of ink. Further, automatic tramming may be implemented for the blade to the roller.

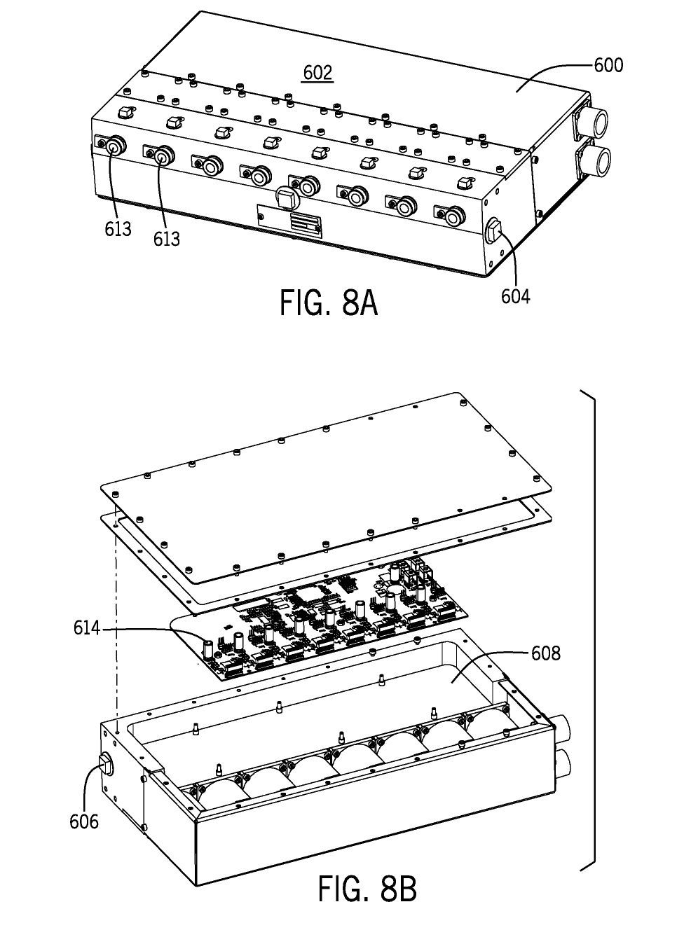

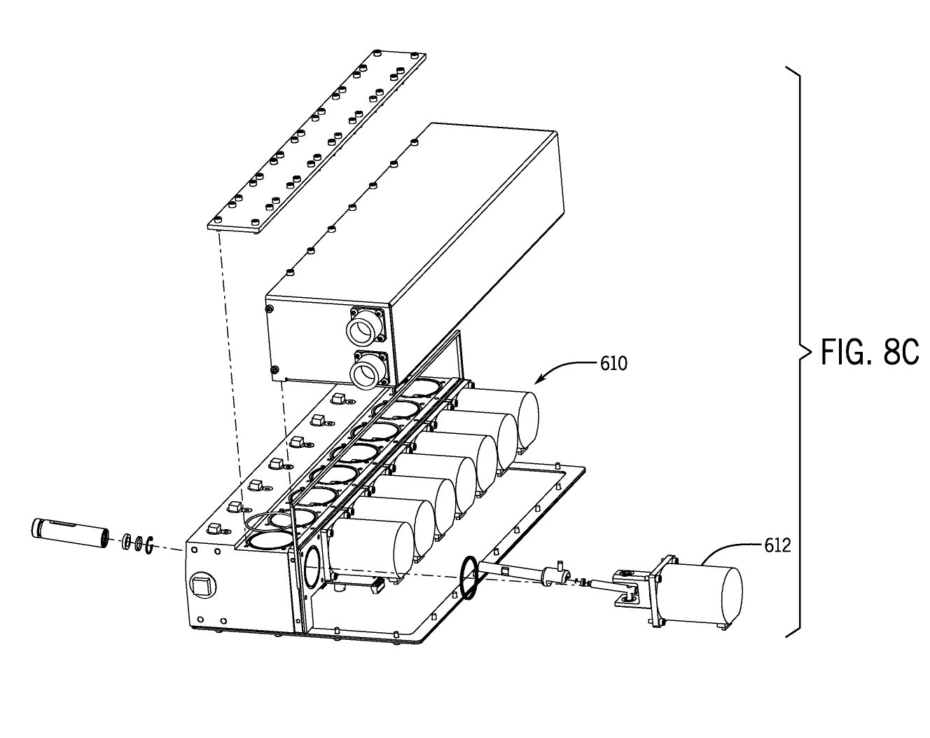

Referring now to FIG. 8A-8C, there are several views of another exemplary pump unit 600. Pump unit 600 comprises a housing 602. Pump unit 600 has a first fluid input port 604 and a second fluid input port 606 (FIG. 606). Both fluid input ports 606 and 604 provide access to an ink chamber or billet 608 accessible by the plurality of pumps 610. Each pump has a respective motor (e.g., motor 612) configured for positive displacement pumping. A circuit board 614 (FIG. 8B) may also be housed for powering the pumps and receiving and processing control signals received from processing circuit 10 (FIG. 1). In one embodiment, each stepper motor may be controlled by a separate microprocessor.

In operation, ink is sourced through one of ports 604, 606 to chamber 608. Pumps control the flow of ink from chamber 608 to individual output ports 613 which are coupled to distribution head 11 (not shown).

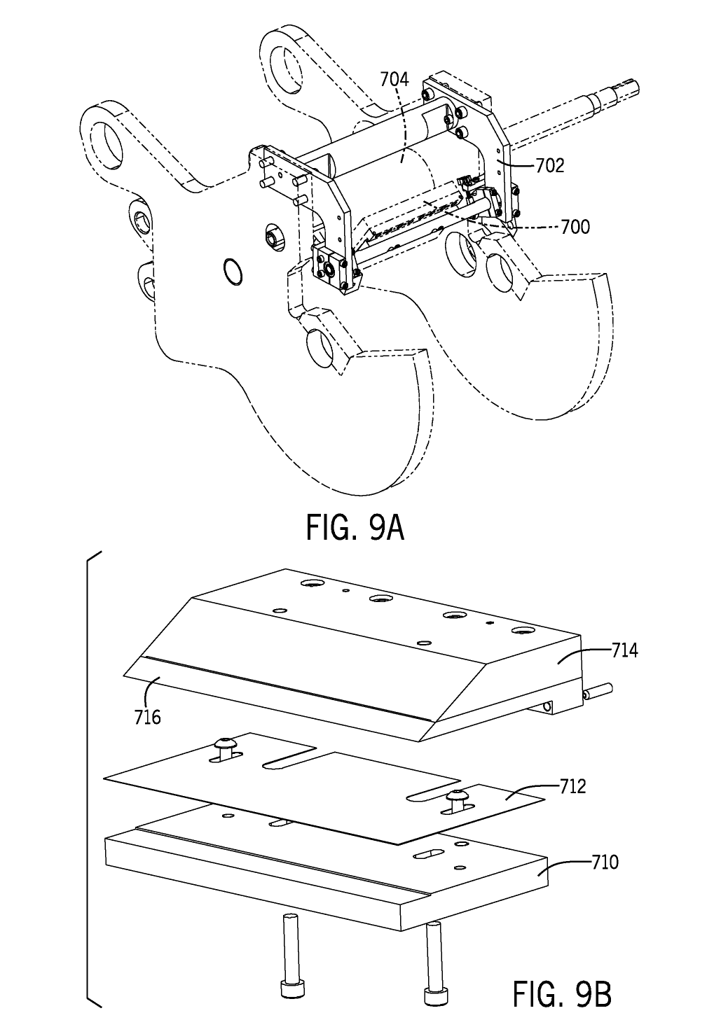

Referring now to FIGS. 9A and 9B, FIG. 9A illustrates an exemplary distribution head 700 mounted to a bracket 702 of a swing frame assembly of a printing press. The swing frame assembly is mounted such that the distribution head is at a predetermined angle and distance from the roller 4. The swing frame assembly can be swung back to simplify cleaning the pump unit 5, channels 12 and distribution head 11. The press has a roller 704 which is inked by the distribution head, which sources ink from the pump unit of FIGS. 8A-8B. In FIG. 9B, distribution head 700 is shown in an exploded view, showing a base part 710, a wiper blade 716 and an angled top part 714. Blade 716 is disposed within a small gap of roller 704 and provides a controlled ink film thickness, thereby limiting the thickness of ink applied to the roller 4.

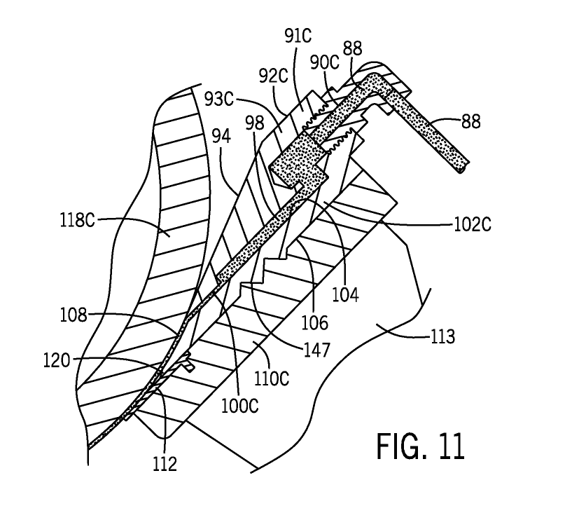

Referring now to FIG. 11, a distribution head according to another illustrative embodiment will be described. In this embodiment, a main body 92C comprises a first portion 93C and a blade holder portion 102C. First portion 93C and blade holder portion 102C define a plurality of ink channels 98C therebetween for the transmission of ink from a pump (not shown) to the roller 118C of the decorator press for printing on metal cans.

First portion 93C and blade holder portion 102C are portions of a single piece of material, such as a one-piece cast or molded or integrally formed unit or member. The single piece of material may be formed in a die casting process. Alternatively, the single piece of material may be machined to form the plurality of ink channels therein. Alternatively, the single piece of material may be manufactured using investment casting, sand casting, wire Electronic Discharge Machining (EDM) (in which a carbon electrode burns away the steel). In some embodiments, main body 92C may be fabricated from a material comprising at least 95% aluminum. In other embodiment, main body 92C may be injection molded using one or more of a variety of different plastic materials such as polycarbonate materials, ABS (Acrylonitrile Butadiene Styrene), Delrin (polyoxymethylene or POM), etc.

As shown, main body 92C defines an aperture 91C and the apparatus further comprises a fitting 90C configured to be coupled by threads to main body 92C within aperture 91C. Fitting 90C may be configured to source the ink from the pump (not shown) to ink channels 98C.

Another feature shown is the use of non-flat or substantially non-flat surfaces in the design. For example, at least a portion of the lower surface of blade holder portion 102C is non-flat, as shown at portion 147. This lower surface is opposite an upper or inner surface 104C which defines at least a portion of ink channels 98. Blade holder portion 102C may have an inner surface 104C defining at least a portion of the ink channels, wherein the inner surface is non-flat (not shown).

The non-flat surfaces may be ridged, as shown at portion 147, or may have other non-flat features, such as stipples, grooves, curves, waves, cracks, etc.

In some embodiments, a single-piece main body may provide more precise tolerances in the size and shape of ink channels defined therein.

In some embodiments, a single-piece main body may reduce the risk of leaks associated with seams in multi-piece embodiments.

In some embodiments, manufacturing time of a single-piece main body may be less than a multi-piece body because there is no need to build up the body from multiple pieces.

In some embodiments, a ridged lower surface 147 may provide an improved coupling between main body 92C and support 110C. In some embodiments, a ridged upper surface 104C may provide a more controlled flow of ink through ink channels having at least a portion of the channel in a non-flat or ridged arrangement. In some embodiments, a ridged or non-flat surface may provide self alignment of two pieces with respect to each other.

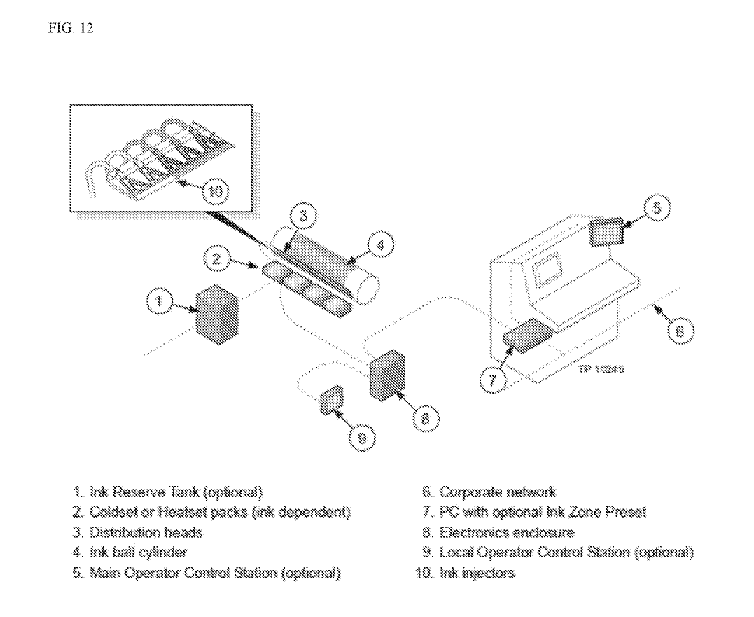

Referring now to FIG. 12, a diagram of a digital inking system according to another illustrative embodiment is shown. This digital ink system uses computer-controlled ink injectors for the density control across the printed image. A main operator control station 5 or local operator control station 9 may be used to set up a print job, run the job and/or monitor and adjust the ink levels for the ink zones. Control station 5 may be in communication with a corporate network 6. Each station 5, 9 may comprise a display configured to provide a graphical user interface screen comprising text, icons, images, and/or other display and/or input devices, such as touch screen portions, etc. An electronics enclosure 8 may couple various components of the system together for communication, control signals, feedback, sensed data, etc.

In this system, the ink supply is delivered to the pack(s) 2 from a pressurized source 1 and then metered by way of distribution heads 3 directly onto a first roller 4 in a roller train. An enclosed ink system protects the ink from press and pressroom contaminants. The system's computer-controlled ink injectors 10 meter and deliver a predetermined volume of ink required in each control zone for consistency based at least in part on a monitored press speed. An optional ink zone preset application running on a computer 7 may be configured to automatically preset the amount of ink in each ink zones according to a prepress image file at job start.

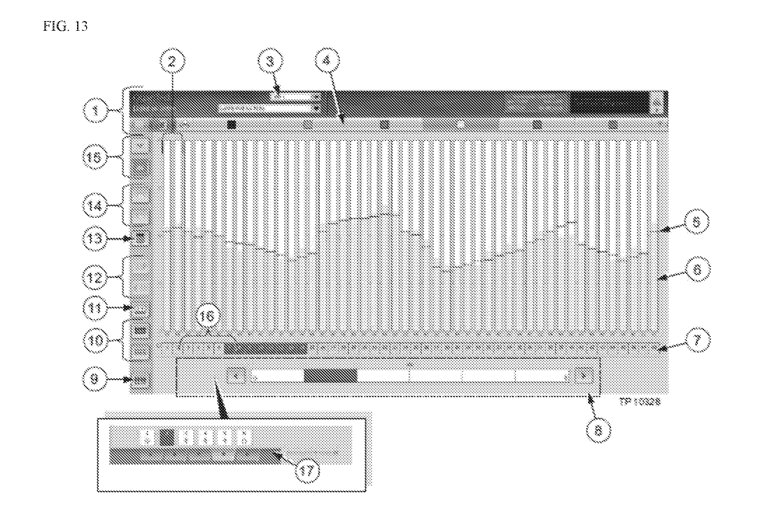

Referring now to FIG. 13, a user interface for a run screen displayed on one of control stations 5, 9 will be described. The run screen allows a press operator to monitor how the digital ink system is maintaining the ink levels. A header/navigation bar area 1 may display the following information: a configuration screen button, a Web drop-down list, a Job drop-down list, a Press information box and a Warning message box. The navigation bar may display the following buttons to access the installed applications and their associated screens: Setup button, Digital Ink System application button, Application buttons for other installed applications, Print Screen button, and Ink Fountain buttons (one for each fountain used in the job).

Ink Zones fields 2 may display is one column for each ink zone on the press, showing the amount of ink being dispensed. Web drop-down list 3 may display the name of the web whose information is in view, which may be pressed to select a different web. Ink Fountain button 4 may be pressed to open the Run screen for the ink fountain. Preset ink level 5 displays a line across the ink zone at the location of the preset value (if applicable). Ink level 6: the height of the bar, in the color of the ink, indicates the current ink level. The numeric value (in %) is also shown in the ink zone selector 7. Ink Zone selector 7: Touching these selectors allow you to select or deselect ink zones. When a zone is selected, the selector is blue (16).

A surface map for alley navigation (8) is provided. This graphic illustrates the alley divisions on the surface in view. Touching an alley in the graphic selects all of the zones in that alley. If necessary, the zones in view update to display the selected zones. Touching an arrow button on either end of the alley navigation graphic, selects the zones in the next alley. If necessary, the zones in view update to display the selected zones. In alternative press configurations, the display will show the surface map or the page navigation (17) controls.

Purge Packs button (9) opens a Purge Packs dialog box. Select/Deselect All Zones buttons (10) selects all of the zones used in the job. The Deselect Zones button deselects all currently selected zones. The Change Zone View button (11) changes the number of zones in view. When all zones are currently in view, touching this button displays a subset of the zones. This widens the zones, allowing for easier selection. When a subset of zones is currently in view, touching this button displays all of the zones on the surface. This allows an operator to see how the entire surface is performing. This button may be shown only when there is a large number of zones on the surface.

View Zones buttons (12) allow an operator to view the next set of zones to the left or right of the current view. These buttons may be shown only when there is a large number of zones on the surface.

Numeric Adjust button (13) may be used to open a keypad dialog box where an operator can enter the ink level. The currently selected ink zones will be changed to this value.

Increase and Decrease Ink Level buttons (14): After selecting one or more ink zones, these buttons may be used to increase or decrease their ink level(s). Surface Select buttons (15) may be used to view the zones for that surface. Selected ink zones (16): When a zone is selected, its face turns blue. Ink level adjustments made using the Numeric Adjust buttons (13) or the Increase and Decrease Ink Level buttons (14) affect the selected zones.

Page navigation (17): These tabs and buttons display if an operator defined page numbers and section names on a layout during job setup. These buttons allow an operator to quickly navigate to the Run screen for a specific printed page. Depending on the press configuration, the system will display the page navigation or the surface map (8) controls.

According to various exemplary embodiments, processing circuit 10 may comprise a memory, a local cache, a local hard disk drive, a CD-ROM, a floppy disk, a random access data source (e.g., a RAM), a read-only data source (e.g., a ROM), an Ethernet port, a communication port, or any other volatile or non-volatile memory. According to various exemplary embodiments, processing circuit 10 may be any processing circuit of past, present, or future design that is capable of carrying out the processes described herein. Processing circuit 10 may comprise analog and/or digital components, such as a microprocessor, microcontroller, application-specific integrated circuit (ASIC), field-programmable gate array (FPGA), or other electronic, mechanical, or electromechanical components, as well as any computer-readable code or software operable therewith or thereon, configured to perform the functions described herein and other functions.

In one embodiment, an apparatus for inking a roller of a decorator press for printing on metal cans comprises a main body disposed in the vicinity of a decorator press for printing on metal cans, a blade holder, and a plurality of ink inlets. The plurality of ink inlets is spaced longitudinally along the length of at least one of the main body and the blade holder, the ink inlets leading to a plurality of ink channels terminating downstream in spreader formations. The main body and the blade holder both have front surfaces that are non-parallel to each other. A blade is coupled to the blade holder. The blade is configured to spread ink from the plurality of ink channels onto the roller of the decorator press for printing on metal cans.

The front surfaces of the main body and blade holder may be inclined so as to be approximately tangent to the roller. The blade, the blade holder and the main body may be adapted to be swung as a unit to a position adjacent said fountain roller of said press. The main body and blade holder may be integrally formed as a single piece. The apparatus may further comprise a pump unit coupled to the ink inlets and configured to pump ink into the inlets. The apparatus may further comprise an operator control unit configured to provide a graphical user interface to an operator on a touch screen. The operator control unit may be configured to receive control inputs for a plurality of different ink keys or zones and to transmit control signals to the pump unit to control flow of ink into the inlets. The front surface of the main body may be at least 5 degrees non-parallel with the front surface of the blade holder.

1. An apparatus for inking a roller of a decorator press for printing on metal cans, the apparatus comprising:
a main body disposed on a decorator press for printing on metal cans, the main body comprising a blade holder portion;
a plurality of ink inlets spaced longitudinally along the length of at least one of the main body and the blade holder portion, the ink inlets leading to a plurality of ink channels terminating downstream from the inlets;
a blade coupled to the blade holder portion, wherein the blade is configured to spread ink from the plurality of ink channels onto the roller of the decorator press for printing on metal cans; and
an adjustment device configured to provide movement of the blade from a first operating position coupled to the blade holder to a second operating position coupled to the blade holder.

2. The apparatus of claim 1, wherein the adjustment device comprises an actuator configured to move the blade between the first operating position and the second operation position.

3. The apparatus of claim 2, wherein the actuator comprises a hydraulic actuator.

4. The apparatus of claim 2, wherein the actuator comprises an electric motor.

5. The apparatus of claim 1, wherein the adjustment device comprises a plurality of apertures within the blade holder portion and a fastener configured to fasten the blade in the first or second operating position by coupling to a respective one of the plurality of apertures.

6. The apparatus of claim 1, wherein the blade is configured to move linearly from the first operating position to the second operating position.

7. The apparatus of claim 1, wherein the blade is configured to move along an arcuate path from the first operating position to the second operating position.

8. The apparatus of claim 1, wherein the adjustment device comprises a spring and is hand-operable by a press attendant.

9. The apparatus of claim 1, wherein the adjustment device is configured to provide movement of the blade into at least three different operating positions.

10. The apparatus of claim 1, wherein the apparatus is configured to apply ink to the roller of the decorator press with the blade in the first operating position and with the blade in the second operating position.

11. An apparatus for inking a roller of a decorator press for printing on metal cans, the apparatus comprising:
a main body disposed on a decorator press for printing on metal cans, the main body comprising a blade holder portion;
a blade coupled to the blade holder portion, wherein the blade is configured to spread ink onto the roller of the decorator press for printing on metal cans; and
a plurality of ink inlets spaced longitudinally along the length of the main body, the ink inlets leading to a plurality of ink channels, wherein each ink channel comprises a main conduit and a spreader portion, the main conduit extending from the ink inlet to the spreader portion, the spreader portion having an outer margin that is straight over the entirety of its length extending from the main conduit to one of the blade and a spreader portion of a neighboring ink channel.

12. The apparatus of claim 11, wherein the spreader portion has a decreasing depth and increasing width from the main conduit to the blade.

13. The apparatus of claim 11, the spreader portion having a second margin opposite the margin, the margin extending gradually outward in one direction and the second margin extending substantially straight from the main conduit to the blade.

14. The apparatus of claim 11, the spreader portion having uniform depth and increasing width from the main conduit to the blade.

15. The apparatus of claim 11, the margin extending to a margin of the spreader portion of a neighboring ink channel, wherein the margins form an acute angle of at least 10 degrees.

16. An apparatus for inking a roller of a decorator press for printing on metal cans, the apparatus comprising:
a main body disposed on a decorator press for printing on metal cans, the main body comprising a first portion and a blade holder portion, the first portion and blade holder portion defining a plurality of ink channels therebetween for the transmission of ink from a pump to the roller of the decorator press for printing on metal cans, wherein the first portion and the blade holder portion are portions of a single piece of material; and
a blade coupled to the blade holder portion, wherein the blade is configured to spread ink onto the roller of the decorator press for printing on metal cans.

17. The apparatus of claim 16, wherein the single piece of material is formed in a die casting process.

18. The apparatus of claim 16, wherein the single piece of material has been machined to form the plurality of ink channels therein.

19. The apparatus of claim 16, wherein the main body defines an aperture and further comprising a fitting configured to be coupled by threads to the main body within the aperture, wherein the fitting is configured to source the ink from the pump to the ink channels.

20. The apparatus of claim 16, wherein the blade holder portion has an inner surface defining at least a portion of the ink channels, wherein the inner surface is non-flat and ridged, wherein the blade holder portion has an outer surface opposite the inner surface, wherein the outer surface is non-flat and ridged, wherein the single piece of material comprises at least 95% aluminum.
